(19) United States
(12) Patent Application Publication
(10) Pub. No.: US 2009/0248206 A1
(43) Pub. Date: Oct. 1, 2009

(54) Control method of laundry treating machine

(76) Inventors: Hea Kyung YOO, Seoul (KR); Sog Kie HONG, Seoul (KR); Dong Won KIM, Seoul (KR); Jong Seok KIM, Seoul (KR); Dae Yun PARK, Seoul (KR)

Correspondence Address: MCKENNA LONG & ALDRIDGE LLP, 1900 K STREET, NW, WASHINGTON, DC, 20006, US

(21) Appl. No.: 12/385,066

(22) Filed: Mar. 30, 2009

(30) Foreign Application Priority Data
Apr. 1, 2008 (KR) 10-2008-0030335

(51) Int. Cl. G05B 15/00; G05D 23/00

(52) U.S. Cl. 700/275; 700/299

(57) ABSTRACT

A control method of a laundry treating machine is disclosed. A control method of a laundry treating machine comprising a cabinet where an accommodating space receiving laundry is formed and a heat pump supplying hot air to the accommodating space, the control method includes driving the heat pump and identifying whether the heat pump is abnormal based on at least one temperature information of the heat pump. An object of the present invention is to provide a control method of a laundry treating machine capable of identifying an operational abnormality thereof conveniently. Another object of the present invention is to provide a laundry treating machine capable of taking an appropriate action for or informing a user of the abnormality thereof, after identifying the abnormality by using at least one temperature information of the laundry treating machine.

### CROSS REFERENCE TO RELATED APPLICATION

This application claims the benefit of the Patent Korean Application No. 10-2008-0030335, filed on Apr. 1, 2008, which is hereby incorporated by reference as if fully set forth herein.

### BACKGROUND OF THE DISCLOSURE

1. Field of the Disclosure

The present invention relates to a laundry treating machine. More particularly, the present invention relates to a control method of laundry treating machine capable of identifying an operational abnormality thereof.

2. Discussion of the Related Art

Laundry treating machines typically include washing machines, dryers and laundry machines having drying and washing functions. In recent, with improvement of standard of living, refreshers have been developed. Here, such a refresher supplies dried air to clothes and cloth items (hereinafter, laundry) received therein.

In a dryer, washing machine having drying and washing function and refresher included in such the laundry treating machine, air is heated or the moisture of air is removed to supply dried or hot air to laundry. For that, a gas or electric type heater may be used and a heat pump is adapted to remove the moisture of the air and to heat the dried air recently.

However, in this case, the temperature of the heat pump might be increased too much problematically. If then, the heat pump would have a disadvantage of safety. In addition, if a path of such the air supply is closed during the supplying the dried or hot air to the laundry, the heat pump operates without supplied air and the temperature of the heat pump will increase too much, which results in its damage.

### SUMMARY OF THE DISCLOSURE

Accordingly, the present invention is directed to a control method of a laundry treating machine.

An object of the present invention is to provide a control method of a laundry treating machine capable of identifying an operational abnormality thereof conveniently.

Another object of the present invention is to provide a laundry treating machine capable of taking an appropriate action for or informing a user of the abnormality thereof, after identifying the abnormality by using at least one temperature information of the laundry treating machine.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a control method of a laundry treating machine comprising a cabinet where an accommodating space receiving laundry is formed and a heat pump supplying hot air to the accommodating space, the control method includes driving the heat pump; and identifying whether the heat pump is abnormal based on at least one temperature information of the heat pump.

The temperature information may be a temperature of refrigerant passing a heat exchanger of the heat pump.

The temperature information may be at least one of a refrigerant temperature of a heat exchanger at an outlet of the heat pump, a refrigerant temperature at an inlet of a condenser of the heat pump and a refrigerant temperature at an outlet of a compressor of the heat pump.

The identifying whether the heat pump is abnormal may include determining that the heat pump is abnormal based on a result of comparing a rate of temperature information change with a reference rate of temperature change.

The control method may further include turning off the heat pump and informing a user that a filter part of the heat pump is choked if the rate of the temperature information change is over the reference rate of the temperature change.

The control method may further include turning off the heat pump and cooling an installation space of the heat pump is mounted if the rate of the temperature information change is below the reference rate of the temperature change and the temperature information is over a predetermined value.

In another aspect, a control method of a laundry treating machine comprising a heat pump, the control method includes driving the heat pump; and identifying whether the heat pump is abnormal based on at least one temperature information of the heat pump, wherein the temperature information comprises a first temperature information on air drawn into a heat exchanger of the heat pump and a second temperature information on a refrigerant temperature of a heat exchanger of the heat pump.

The first temperature information may be an air temperature at an inlet of an evaporator of the heat pump.

The second temperature information may be a refrigerant temperature at an outlet of a compressor of the heat pump.

The control method may further include turning off the heat pump and informing a user that filter part of the heat pump is choked if the first temperature information is below a first reference temperature and the second temperature information is over a second reference temperature.

The control method may further include turning off the heat pump and cooling space where the heat pump is mounted if the first temperature information and the second temperature information are over the first reference temperature and the second reference temperature, respectively.

The control method may further include turning off the heat pump and cooling space where the heat pump is mounted if the first temperature information is over the first reference temperature and the second temperature information is below the second reference temperature.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a front view illustrating a laundry treating machine a control method according to an exemplary embodiment of the present invention is applicable;

FIG. 2 is a diagram schematically illustrating an inner configuration of a mechanism room shown in FIG. 1;

FIG. 3 is a diagram schematically illustrating heat pump shown in FIG. 2;

FIG. 4 is a flow chart of a control method according to an exemplary embodiment of the present invention; and

FIG. 5 is a flow chart of a control method according to another embodiment of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

The present specification presents a refresher supplying hot or dried air to laundry for refreshing as laundry treating machine and the present invention is not limited there to. That is, the subject matter of the present invention may be applicable to other types of laundry treating machines, for example, dryers and laundry machines having drying and washing functions. Next, a structure of the laundry treating machine according to the present invention will be described and a control method of the laundry treating machine according to the present will be described.

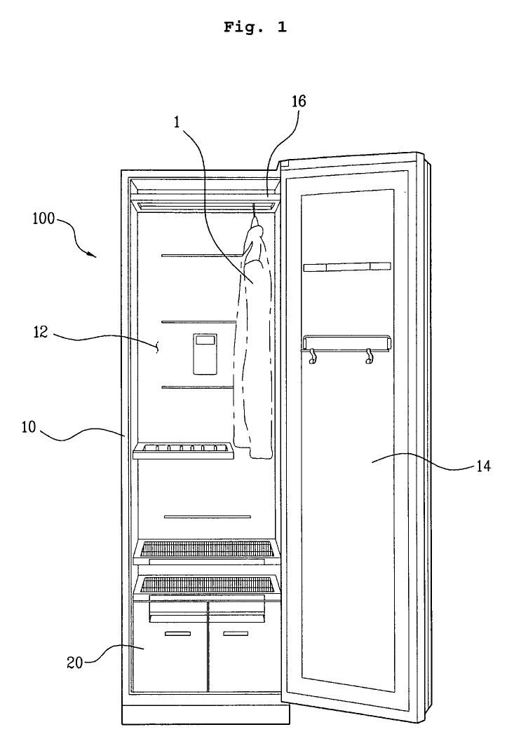

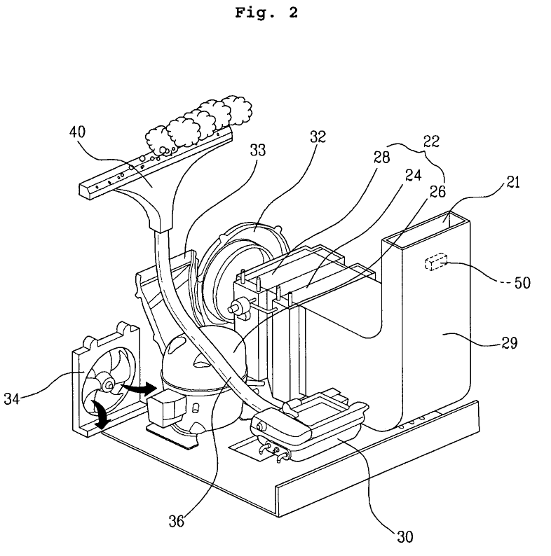

In reference to FIG. 1, a laundry machine according to an exemplary embodiment of the present invention includes a cabinet 10, a hot air supply device (22, see FIG. 2), at least one sensor (50, see FIG. 2) and a control part (not shown. In the cabinet 10 may be formed an accommodating space receiving laundry 1 therein. The hot air supply device 22 supplies hot air to the accommodating space 12 the at least one sensor 50 senses a temperature inside the cabinet 10 and the control part controls the laundry treating machine according to the temperature information sensed by the sensor 50.

Specifically, in the cabinet may be provided various elements which will be described later and the accommodating space 12 receiving the laundry 1 therein. Such the accommodating space 12 is selectively in contact with an outside by a door 14 and it includes various supporters 16 where the laundry 1 may be hung. Here, the configuration of supporting the laundry 1 is well-known in the air to which the present invention pertains and a detailed description thereof will be omitted.

A mechanism room 20 may be formed in the cabinet 10 and the hot air supply device 22 is mounted in the mechanism room 20. The mechanism room 20 may be positioned under the accommodating space 12 and mechanical devices including the hot air supply device 22 may be provided in the mechanism room 20. The reason why the mechanism room 20 is provided under the accommodating space 12 is that the air supplied to the accommodating space 12 tends to ascend upward. As a result, it is preferable that hot air is supplied upward from the mechanism room 20 provided under the accommodating space 10.

FIG. 2 is a perspective view schematically illustrating an inner configuration of the mechanism room 20. Only elements of a heat pump 22 provided in the mechanism room 20 are shown in FIG. 2 for convenience's sake and a refrigerant pipe path connecting the elements of the heat pump 22 is not shown.

In reference to FIG. 2, a heat pump 22 is positioned in the mechanism room 20 as hot air supply device capable of supplying hot air to the accommodating space (12, see FIG. 1).

The heat pumps 22 employed as the hot air supply device of the present invention is similar to a heat pump used in an air conditioner.

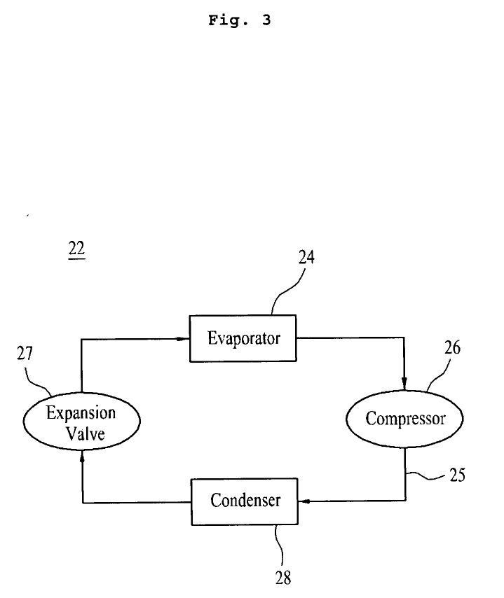

FIG. 3 is diagram schematically illustrating a configuration of the heat pump. In reference to FIG. 3, the heat pump 22 includes an evaporator 24, a compressor 26, a condenser 28 and an expansion valve 27, which refrigerant passes sequentially. These elements make air dehumidified and heated. Specifically, the evaporator 24 positioned at an input of the heat pump 22 evaporates refrigerant, absorbing latent heat of the drawn air, to cool the air by condensing the air and to remove the moisture of the air. Hence, the refrigerant having passed the compressor 26 is condensed at the condenser 28 positioned at an outlet of the heat pump 22. At this time the latent heat is exhausted toward ambient air and the ambient air is heated. Because of that, the evaporator 24 and the condenser 28 may be employed as a heat exchanger having a heat exchanging function and then the air drawn into the mechanism room 20 is supplied to the accommodating space 12 after being dehumidified and heated, passing the evaporator 24 and the condenser 28.

The temperature of the air heated by the heat pump 20 may be substantially lower than the air heated by the conventional heater. However, the air may be dehumidified in the present invention, without any auxiliary dehumidifying devices. Here, the air re-supplied to the accommodating space 12 by the heat pump 22 is corresponding to relatively ‘low temperature dried air’. At this time, the term ‘low temperature air’ is heated air having a relatively low temperature, compared with the air heated by the conventional heater, not air having a substantially low temperature. While the temperature of the air supplied by the heat pump 22 according to the present invention is relatively lower than the hot air of the conventional washing machine, the heat pump 22 according to the present invention may supply dehumidified air without any auxiliary dehumidifying devices and it enables the laundry to be dried and refreshed conveniently and simply.

In reference to FIG. 2 again, an inlet 21 is formed at a front portion of a top of the mechanism room 20 and air inside the accommodating space 12 is drawn into the mechanism room 20. A circulation duct 29 connecting the inlet 21, the evaporator 24, the condenser 28 and a fan 32 may form a path which the air flow along. The air drawn into the mechanism room 20 through the inlet 21 by the circulation duct 29 is dehumidified and heated, while passing the heat pump. Hence, the dehumidified dry air is re-supplied to the accommodating space 12 through an outlet 33 by the fan 32.

Although not shown in the drawings, a filter may be provided at the inlet 21. The filter provided at the inlet 21 may make it possible to filter various foreign substances which could be contained in the air drawn into the mechanism room 20 from the accommodating space and to supply only fresh air to the accommodating space 12.

On the other hand, a steam generator 30 capable of selectively supplying steam to the accommodating space 12 may be provided in the mechanism room 20. Wrinkles which would be generated on the laundry by the steam supplied to the accommodating space 12 by the steam generator 30 may be removed. Moreover, the supplying of the steam may result in a sterilization effect and a refresh effect caused by fabric bulking. A timing of spraying such the steam may be variable appropriately and it is preferable that the steam supplying is performed prior to the hot air supplying performed by the heat pump 22. This is because the laundry is dried by the hot air supplied after the high temperature steam sprayed to the laundry.

A heater (not shown) is provided in the steam generator 30 to heat water inside and to generate steam which will be supplied to the accommodating space 12.

An external water tap or a container type provided in the mechanism room 20 may be useable as a water supply source supplying water to the steam generator 30. Such the container type water supply source may be detachable such that the user fill up the container type water supply source with water and re-install it after separating the water supply source from the mechanism room 20.

Hence, the steam generated by the steam generator 30 is supplied to the accommodating space 12 via a steam hose 36 and a steam nozzle 40. Here, the shorter the length of the steam hose 36 is, the more preferable it is to prevent the temperature of the steam from going down or the steam from being condensed. As a result, if the mechanism room 20 is provided under the accommodating space 12, the steam nozzle 40 may spray steam through the top of the mechanism room 20, that is, the bottom of the accommodating space 12.

Furthermore, a circulation fan 34 may be provided at a rear of the mechanism room 20 the circulation fan 34 blows external air of the mechanism room 20 toward the inside of the mechanism room 20, such that the temperature inside the mechanism room 20 may not increase too much because of the operations of the heat pump 22 and the steam generator 30 described above.

If the circulation duct 29, especially, a filter (not shown) is clogged during the supplying of the hot or dried air to the accommodating space 12 by the heat pump 22, the hot or dried air fails to be supplied to the accommodating space 12 and then only the heat pump 22 is operated. This could cause overload and damage of the heat pump 22. Also, if the temperature inside the mechanism room 20, where the heat pump 22 is positioned, increases too much, the temperature of the compressor 26 composing the heat pump 22 would increase accordingly only to deteriorate safety of the compressor 26.

However, the laundry treating machine having the above configuration have not way of sensing the clogged state of the circulation duct 29 or the filter part or sensing a too high temperature of the mechanism room 20.

There have been increasing demands for a laundry treating machine and a control method of the same capable of sensing a clogging state of the filter part or sensing a too high temperature inside the mechanism room 20.

According to such the demands, the laundry treating machine 100 of the exemplary embodiment of the present invention may include a sensor capable of sensing information on at least one temperature of the heat pump 22. At least one sensor may be installed. However, considering precise temperature sensing, precise identification of abnormality of the laundry treating machine and convenience of controlling the sensor, it is preferable that one or two sensors may be provided.

If a single sensor is provided according to an exemplary embodiment, the single sensor may sense a temperature of refrigerant inside the heat exchanger of the heat pump 220, especially, a temperature of refrigerant inside the condenser 28 employed as the heat exchanger of the heat pump 22.

Specifically, the sensor may be along a refrigerant line 25 connecting the compressor 26 and the condenser 28 each other to sense a refrigerant temperature of the heat exchanger positioned at the outlet of the heat pump 22, that is, a refrigerant temperature of an inlet end of the condenser 28 or a refrigerant temperature of an outlet end of the compressor 26, shown in FIG. 3.

Specifically, a driving pressure and a driving temperature are important elements in the driving of the compressor 26 composing the heat pump 22. If the single sensor is installed, it is preferable that the sensor senses the temperature of the refrigerant discharged from the compressor 26 or the temperature of the refrigerant drawn into the condenser from the compressor 26 to expect the temperature of the compressor 26.

In case of the single sensor, the temperature information sensed by the senor is transmitted to the control part and the control part determines whether there is operational abnormality of the laundry treating machine. Such the control method will be described later.

Alternatively, if the two sensors are provided in a laundry treating machine according to another embodiment of the present invention, that is, first and second sensors are provided, the first sensor (50, see FIG. 2) may be provided to sense a temperature of air drawn into the heat pump 22 and the second sensor may be provided to sense the refrigerant temperature of the heat exchanger composing the heat pump 22, which is similar to the embodiment described above. If then, the description of the second sensor is similar to that of the single sensor in the above embodiment and the repeated description will be omitted.

The first sensor 50 may sense temperature information of air passing the heat exchanger positioned at the inlet of the heat pump 22, that is, the temperature of the air passing the evaporator 24 of the heat pump 22. For that, the first sensor 50 senses the temperature of the air discharged from the accommodating space 12 and drawn into the mechanism room 20. Specifically, the first sensor 50 may be positioned at a front end of the evaporator 24 along the circulation duct 29.

The first temperature information and the second temperature information sensed by the first sensor 50 and the second sensor may be transmitted to the control part. Hence, the control part determines whether there is operational abnormality of the laundry treating machine based on the received first and second temperature information. Next, a control method for that will be described in reference to the corresponding drawings.

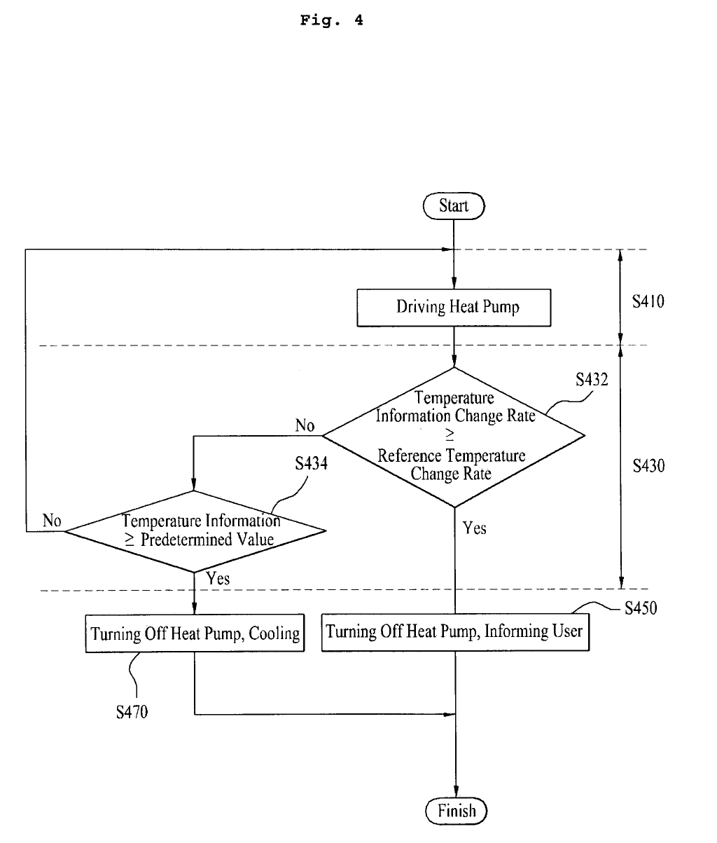

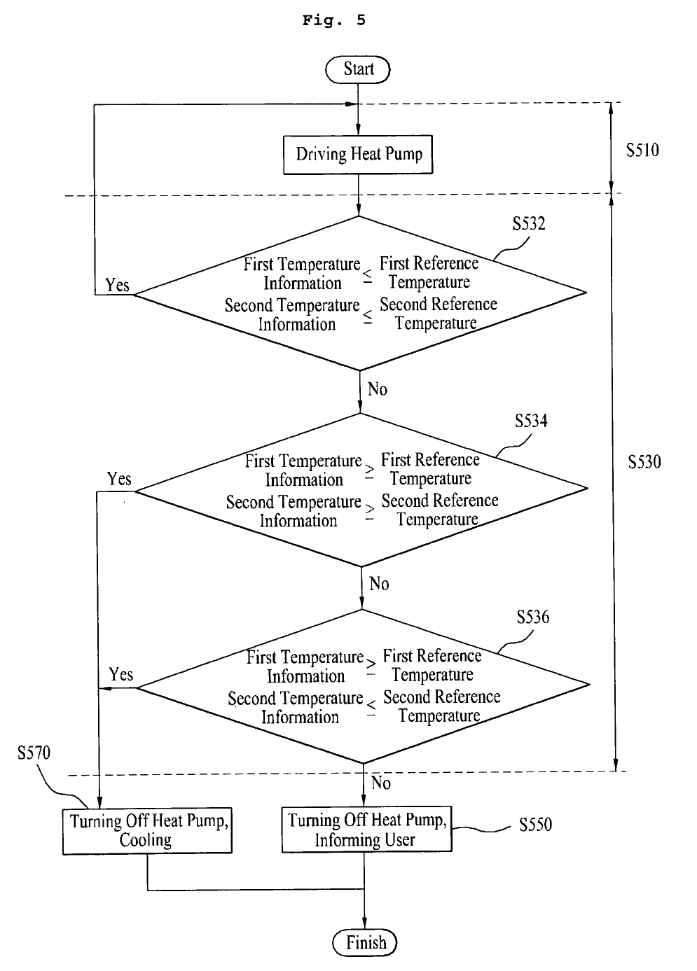

FIG. 4 is a flow chart illustrating a method of controlling the laundry treating machine based on the single temperature information if the single sensor is provided and FIG. 5 is a flow chart illustrating a method of controlling the laundry treating machine based on the two pieces of the temperature information if the two sensors are provided.

In reference to FIGS. 4 and 5, a control method of the laundry treating machine according to an exemplary embodiment includes driving the heat pump 22 (S410 and S510) and identifying whether there is an operational abnormality of the heat pump 22 based on information on at least one temperature of the heat pump 22 (S43 and S530). Next, in reference to the corresponding drawings, the steps will be described sequentially.

In reference to FIG. 4, the user loads the laundry into the laundry treating machine and starts the laundry treating machine. Then, the hot air supply device, that is, the heat pump of the laundry treating machine is operated (S410).

In this case, the sensor provided along the refrigerant line 25 connecting the compressor 26 and the condenser 28 senses the refrigerant temperature of the heat exchanger positioned at the outlet end of the heat pump 22, that is, the temperature of the refrigerant at the inlet of the condenser 28 or at the outlet of the compressor 26 and it transmits the sensed temperature information to the control part.

The control part determines whether there is an operational abnormality of the laundry treating machine based on the received temperature information. Specifically, the control part determines whether the heat pump 22 is abnormal based on the result of the comparing a rate of temperature information change with a preset reference rate (S432).

In case that it is identified based on the single piece of temperature information, a reference rate of temperature change is preset in the control part and the control part calculates the rate of temperature changes received by the sensor. Hence, the control part compares the calculated rate of temperature information change with the preset reference rate of temperature change to identify whether the laundry treating machine is abnormal. Then, the reference rate of temperature change preset in the control part may be changeable according to the size of the laundry treating machine, the volume of the accommodating space and the capacity of the heat pump and thus it is not limited to a specific value in the present specification.

More specifically, if the rate of the received temperature information change is over the reference rate of the temperature change when the control part determines whether the laundry treating machine is abnormal based on the single temperature information, it is determined that the filter part of the heat pump 22 is choked.

That is, if the refrigerant temperature of the heat exchanger positioned at the outlet of the heat pump 22, that is, the refrigerant temperature at the inlet of the condenser 28 of the heat pump 22 or at the outlet of the compressor 26 of the heat pump 22 increases drastically for the rate of temperature information change to be over the reference rate of temperature change, it is determined that the filter part, where the air is drawn into the heat pump 22, is choked. This is because the heat pump 22 is driven without the air supposed to be drawn into the heat pump 22.

If then, the control part turns off the heat pump 22 and it informs the user of the choking of the filter part (S450). When informing the user, an audio signal, for example, a buzzer and an alarm or a video signal, for example, a warning message may be used.

If the rate of the received temperature information change is below the reference temperature change rate when the control part determines whether the laundry treating machine is abnormal based on the single temperature information, a step S434 of comparing the received temperature information with a predetermined value preset in the control part may be performed further.

If the rate of the received temperature information is below the reference temperature change rate, it is determined that the filter part is not choked. However, the comparing step is to determine whether the temperature of surroundings near the heat pump 22, that is, the inside of the mechanism room 20 is high. The predetermined value preset in the control part is changing according to the size of the laundry treating machine, the volume of the accommodating space and the capacity of the heat pump and it is not limited to a specific one. However, for example, it may be preset between 90° C. and 110° C.

As a result, if the rate of the received temperature information is below the reference temperature change rate and the received temperature information is over the predetermined value, the control part determines that the temperature of the space where the heat pump 22 is mounted, that is, the temperature of the inside of the mechanism room 20 is high.

In this case, the control part turns off the heat pump 22 and it cools the mechanism room 20 (S470). When cooling the mechanism room 20, the control part drives the circulation fan 34 provided in the mechanism room 20 at a normal or high rotation number such that external fresh air may be supplied to and cools the mechanism room 20.

FIG. 5 is a flow chart illustrating a control method determining whether the laundry treating machine is abnormal based on the two temperature information, that is, the first temperature information and the second temperature information received by the two sensors provided in the laundry treating machine.

As mentioned above, the first sensor 50 senses the temperature information of the air passing the heat exchanger positioned at the inlet of the heat pump 22, that is, the evaporator 24 of the heat pump 22 the second sensor may be provided along the refrigerant line 25 connecting the compressor 26 and the condenser 28 and it senses the refrigerant temperature of the heat exchanger positioned at the outlet of the heat pump 22, that is, the refrigerant temperature at the inlet of the condenser 28 of the heat pump 22 or at the outlet of the compressor 26 of the heat pump 22.

The temperature information sensed by the first and second sensors may be transmitted to the control part and the control part determines whether the laundry treating machine is abnormal based on the transmitted first and second temperature information.

When it is determined whether the laundry treating machine is abnormal based on the two temperature information, the temperature change rate may be used, similar to the above embodiment. However, to determine the abnormal state of the laundry treating machine precisely, the first and second temperature information is compared with their reference temperature values, respectively, to determine the abnormal state of the laundry treating machine.

That is, it is preferable that first and second reference temperatures supposed to be compared with the first and second temperature information, respectively, are preset in the control part. Such the first and second reference temperature values will be compared with the temperature information sensed by the sensor and such the comparison makes it possible to determine whether the laundry treating machine is abnormal.

Such the reference temperature may be changeable according to the size of the laundry treating machine, the volume of the accommodating space and the capacity of the heat pump and it is not limited to a specific value for example, the first reference temperature is preset between 40° C. and 60° C. and the second reference temperature may be preset between 90° C. and 11° C.

Similar to the above embodiment, the heat pump 22 is driven first (S510) and the first and second temperature information may be compared with the first and second reference temperatures, respectively, and it is determined that laundry treating machine is abnormal based on the result of the comparison (S530).

Specifically, if the first and second temperature information is below the first and second reference temperatures, respectively (S553), the control part determines that the filter part of the laundry treating machine is not choked, by extension, that the temperature of the inside of the mechanism room 20, where the heat pump 22 is mounted, is normal. If then, the control part drives the heat pump 22 without specific corresponding steps.

If the first temperature information and the second temperature information are over the first reference temperature and the second reference temperature, respectively, the control part determines that the temperature of the space where the heat pump is mounted is nigh (S534).

In other words, the information of the air passing the evaporator 24 of the heat pump 22, which is corresponding to the first temperature information, is over the first reference temperature and the refrigerant temperature at the inlet of the condenser 28 of the heat pump 22 or at the outlet of the compressor 26 of the heat pump 22, which is corresponding to the second temperature information, is over the second reference temperature, the control part determines that the temperature inside the mechanism room 20, where the heat pump 22 is mounted, is high, the control part determines that the inner space of the mechanism room 20, where heat pump is mounted, is high.

Hence, the control part turns off the heat pump 22 and it cools the space where the heat pump 22 is mounted, that is, the inner space of the mechanism room 20 (S570).

In the meanwhile, even if the first temperature information is over the first reference temperature and the second temperature information is below the second reference temperature in the determining step (S530), the control part determines that the temperature of the mechanism room 20 where the heat pump 22 is mounted is high (S536).

Specifically, in this case, the second temperature information is below the second reference temperature and the temperature of the air drawn into the heat pump 22 is high. As a result, the second temperature information would increase possibly and it is determined that the temperature of the mechanism room 20 is high.

Hence, the control part turns off the heat pump 22 and it cools the mechanism room 20 where the heat pump 22 is mounted (S570).

If the first temperature information is below the first reference temperature and the second temperature information is over the second reference temperature in the determining step (S530), the control part determines that the filter part of the heat pump 22 is choked.

The temperature of the air passing the evaporator 24 of the heat pump 22, which is corresponding to the first temperature information, is below the first reference temperature and the refrigerant temperature at the inlet of the condenser 28 or at the outlet of the compressor 26 of the heat pump 22, which is corresponding to the second temperature information, is over the second reference temperature, the control part determines that the filter part through which the air is drawn into the heat pump 22 is choked. As the filter part is choked, the first temperature information is below the first reference temperature and the amount of the air drawn into the heat pump 22 is getting reduced for the second temperature information only to increase over the second reference temperature.

As a result, the control part turns off the heat pump 22 and it informs the user that the filter part is choked (S550). Hence, the control part transmits the audio signal such as a buzzer or an alarm or the video signal such as a washing message to inform the user that.

Therefore, as mentioned above, the control method of the laundry treating machine according to the present invention may make it identified conveniently whether the laundry treating machine is abnormal based on the at least one temperature information.

Furthermore, it may be identified whether the air supply path is choked and whether the heat pump generating dried and hot air is abnormal based on the at least one temperature information.

A still further, the problems of the coking of the air supply path, the abnormal state of the heat pump capable of generating dried and hot air, if they happen, may be fixed appropriately.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A control method of a laundry treating machine comprising a cabinet where an accommodating space receiving laundry is formed and a heat pump supplying hot air to the accommodating space, the control method comprising:
driving the heat pump; and
identifying whether the heat pump is abnormal based on at least one temperature information of the heat pump.

2. The control method of claim 1, wherein the temperature information comprises a temperature of refrigerant passing a heat exchanger of the heat pump.

3. The control method of claim 2, wherein the temperature information comprises at least one of a refrigerant temperature of a heat exchanger at an outlet of the heat pump, a refrigerant temperature at an inlet of a condenser of the heat pump and a refrigerant temperature at an outlet of a compressor of the heat pump.

4. The control method of claim 3, wherein the identifying whether the heat pump is abnormal comprising:
determining that the heat pump is abnormal based on a result of comparing a rate of temperature information change with a reference rate of temperature change.

5. The control method of claim 4, further comprising:
turning off the heat pump and informing a user that a filter part of the heat pump is choked if the rate of the temperature information change is over the reference rate of the temperature change.

6. The control method of claim 4, further comprising:
turning off the heat pump and cooling an installation space of the heat pump if the rate of the temperature information change is below the reference rate of the temperature change and the temperature information is over a predetermined value.

7. A control method of a laundry treating machine comprising a heat pump, the control method comprising:
driving the heat pump; and
identifying whether the heat pump is abnormal based on at least one temperature information of the heat pump, wherein the temperature information comprises a first temperature information on air drawn into a heat exchanger of the heat pump and a second temperature information on a refrigerant temperature of a heat exchanger of the heat pump.

8. The control method of claim 7, wherein the first temperature information comprises an air temperature at an inlet of an evaporator of the heat pump.

9. The control method of claim 7, wherein the second temperature information comprises a refrigerant temperature at an outlet of a compressor of the heat pump.

10. The control method of claim 7, further comprising:
turning off the heat pump and informing a user that filter part of the heat pump is choked if the first temperature information is below a first reference temperature and the second temperature information is over a second reference temperature.

11. The control method of claim 7, further comprising:
turning off the heat pump and cooling space where the heat pump is mounted if the first temperature information and the second temperature information are over the first reference temperature and the second reference temperature, respectively.

12. The control method of claim 7, further comprising:
turning off the heat pump and cooling space where the heat pump is mounted if the first temperature information is over the first reference temperature and the second temperature information is below the second reference temperature.
